(19) United States
(12) Patent Application Publication
(10) Pub. No.: US 2026/0301480 A1
(43) Pub. Date: Oct. 1, 2026

(54) VEHICLE

(71) Applicant: SUBARU CORPORATION, Tokyo (JP)

(72) Inventor: Hironori KUROE, Tokyo (JP)

(21) Appl. No.: 19/553,582

(22) Filed: Mar. 2, 2026

(30) Foreign Application Priority Data
Mar. 28, 2025 (JP) 2025-057354

(51) Int. Cl. G07C 5/04; H02K 7/116; H02K 9/19

(52) U.S. Cl. CPC G07C 5/04; H02K 7/116; H02K 9/19

(57) ABSTRACT

A vehicle includes a drive motor, a gear, an oil circuit, a sensor, and a control device. The gear transmits power from the drive motor to wheels of the vehicle. The oil circuit is supplies oil to the drive motor and the gear. The sensor detects a target temperature that is a temperature of the drive motor, the gear, or the oil. The control device includes one or more processors and one or more memories coupled to the one or more processors. The one or more processors execute a process including: estimating the target temperature based on driving state information that is information on a driving state of the drive motor; and diagnosing an abnormality in the oil circuit based on a result of a comparison between an estimated value of the target temperature and a detected value of the target temperature detected by the sensor.

### CROSS-REFERENCE TO RELATED APPLICATIONS

The present application claims priority from Japanese Patent Application No. 2025-057354 filed on Mar. 28, 2025, the entire contents of which are hereby incorporated by reference.

### BACKGROUND

The disclosure relates to a vehicle.

Conventionally, vehicles are provided with an oil circuit for cooling or lubricating components mounted on the vehicle. For example, Japanese Unexamined Patent Publication No. 2016-65552 discloses a technique in which a hydraulic pressure sensor is provided in the oil circuit, and an abnormality in the oil circuit is detected based on a detected value of the hydraulic pressure sensor.

### SUMMARY

An aspect of the disclosure provides a vehicle including a drive motor, a gear, an oil circuit, a sensor, and a control device. The gear is configured to transmit power from the drive motor to wheels of the vehicle. The oil circuit is configured to supply oil to the drive motor and the gear. The sensor is configured to detect a target temperature that is a temperature of the drive motor, the gear, or the oil. The control device includes one or more processors and one or more memories coupled to the more processors. The more processors are configured to execute a process including: estimating the target temperature based on driving state information that is information on a driving state of the drive motor; and diagnosing an abnormality in the oil circuit based on a result of a comparison between an estimated value of the target temperature and a detected value of the target temperature detected by the sensor.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a vehicle according to an embodiment of the disclosure;

FIG. 2 is a schematic configuration diagram of an oil circuit according to the embodiment;

FIG. 3 is a block diagram illustrating an example of the configuration of a control device according to the embodiment;

FIG. 4 is a block diagram illustrating an example of the functional configuration of the control device according to the embodiment;

FIG. 5 is a diagram illustrating an example of a motor heat generation map according to the embodiment;

FIG. 6 is a diagram illustrating an example of a motor heat dissipation map according to the embodiment;

FIG. 7 is a diagram illustrating an example of an oil flow rate map according to the embodiment;

FIG. 8 is a diagram illustrating an example of a motor temperature map according to the embodiment;

FIG. 9 is a diagram illustrating an example of a motor heat absorption map according to the embodiment;

FIG. 10 is a diagram illustrating an example of a gear heat absorption map according to the embodiment;

FIG. 11 is a diagram illustrating an example of a gear heat generation map according to the embodiment;

FIG. 12 is a diagram illustrating an example of an oil heat dissipation map according to the embodiment; and

FIG. 13 is a diagram illustrating an example of an oil temperature map according to the embodiment.

### DETAILED DESCRIPTION

By the way, in a vehicle, for example, there are cases where shifting of the transmission is not performed hydraulically but is performed electrically. In such cases, because no hydraulic pressure sensor is provided in the oil circuit, an abnormality in the oil circuit, such as damage to a pump provided in the oil circuit or clogging of the oil circuit, is no longer undetectable based on a detected value of the hydraulic pressure sensor.

Accordingly, it is desirable to detect an abnormality in the oil circuit.

Hereinafter, an embodiment of the disclosure will be described in detail with reference to the accompanying drawings. The specific dimensions, materials, numerical values, and the like discussed in the embodiment are merely illustrative examples provided to facilitate understanding of the disclosure and are not intended to limit the disclosure unless otherwise specified. Note that, in the present specification and drawings, elements having substantially the same functions and configurations are denoted by the same reference numerals, and redundant descriptions thereof are omitted. Additionally, elements not directly related to the disclosure are omitted from the drawings.

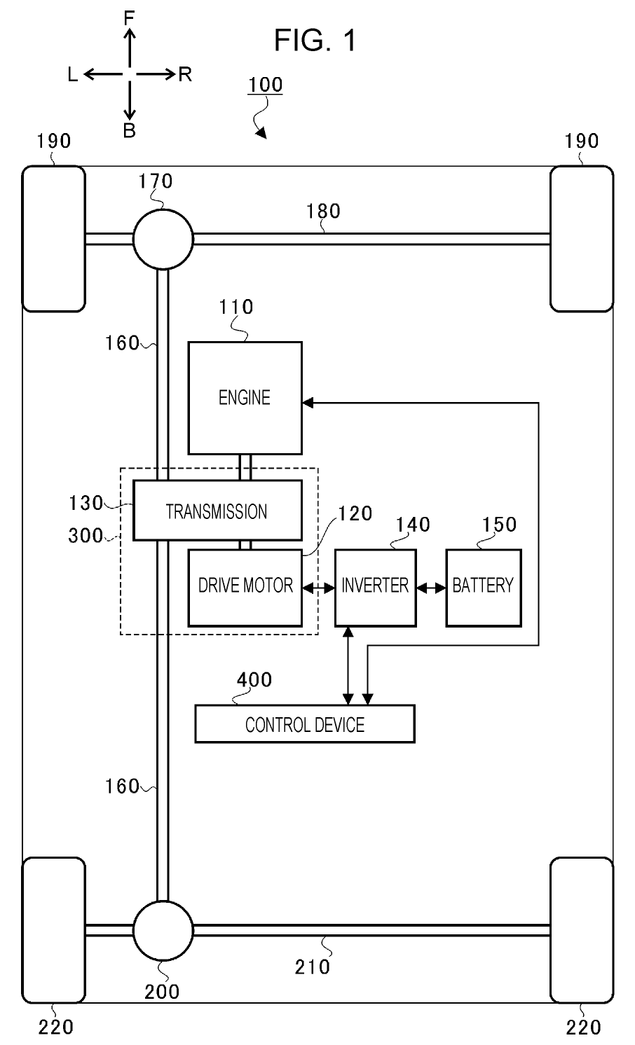

FIG. 1 is a schematic diagram illustrating a vehicle 100 according to the embodiment. In FIG. 1, arrow F indicates the forward direction of the vehicle 100, arrow B indicates the backward direction of the vehicle 100, arrow R indicates the rightward direction of the vehicle 100, and arrow L indicates the leftward direction of the vehicle 100.

The vehicle 100 is a hybrid vehicle equipped with two drive sources: an engine 110 and a drive motor 120. Note that the vehicle 100 may alternatively employ the engine 110 or the drive motor 120 alone as the drive source; various types of vehicles such as an engine-driven vehicle and an electric vehicle can be adopted. Here, the configurations relevant to the features of the embodiment will be described in detail, while configurations irrelevant to the features of the embodiment will be omitted from the description.

As illustrated in FIG. 1, the vehicle 100 includes the engine 110, the drive motor 120, a transmission 130, an inverter 140, a battery 150, a propeller shaft 160, a front differential gear 170, a front drive shaft 180, front wheels 190, a rear differential gear 200, a rear drive shaft 210, rear wheels 220, an oil circuit 300, and a control device 400. The front wheels 190 and the rear wheels 220 constitute the wheels of the vehicle 100.

The engine 110 is composed of a gasoline engine or a diesel engine. The engine 110 obtains driving power by combusting fuel, such as gasoline or diesel fuel, supplied from a fuel tank (not illustrated).

In one example, the engine 110 is provided with an injector (not illustrated) and a spark plug (not illustrated). The injector injects fuel to supply it into a combustion chamber (not illustrated). The spark plug has its tip disposed inside the combustion chamber and ignites a mixture of the fuel and air that has been supplied into the combustion chamber. The mixture of the fuel and air is ignited by the spark plug at a predetermined timing and is combusted. Through this combustion, the engine 110 is able to obtain driving power.

The engine 110 transmits the obtained driving power to the transmission 130. The engine 110 is coupled to the control device 400, and, based on control commands from the control device 400, the operations of the injector and the spark plug are controlled, thereby adjusting the driving power.

The drive motor 120 is disposed coaxially with the engine 110. The drive motor 120 obtains driving power using electric power supplied from the battery 150 via the inverter 140. The drive motor 120 transmits the obtained driving power to the transmission 130. The drive motor 120 can also serve as a generator when electric power is not being supplied. The electric power generated by the drive motor 120 is stored in the battery 150 via the inverter 140. The inverter 140 is coupled to the control device 400, and, based on control commands from the control device 400, the supplied electric power, i.e., the driving power of the drive motor 120, is controlled.

The driving power output from the drive sources such as the engine 110 and the drive motor 120 is adjusted in torque, rotational speed, and rotational direction by the transmission 130, and is transmitted to the propeller shaft 160. The driving power transmitted to the propeller shaft 160 is then transmitted to the front wheels 190 via the front differential gear 170 and the front drive shaft 180. The driving power transmitted to the propeller shaft 160 is also transmitted to the rear wheels 220 via the rear differential gear 200 and the rear drive shaft 210.

The transmission 130 includes various gears and shafts for changing the torque, rotational speed, and rotational direction of the driving power output from the engine 110 and the drive motor 120, and transmitting the driving power. In the embodiment, shift control of the transmission 130 is not performed hydraulically but is performed electrically, for example.

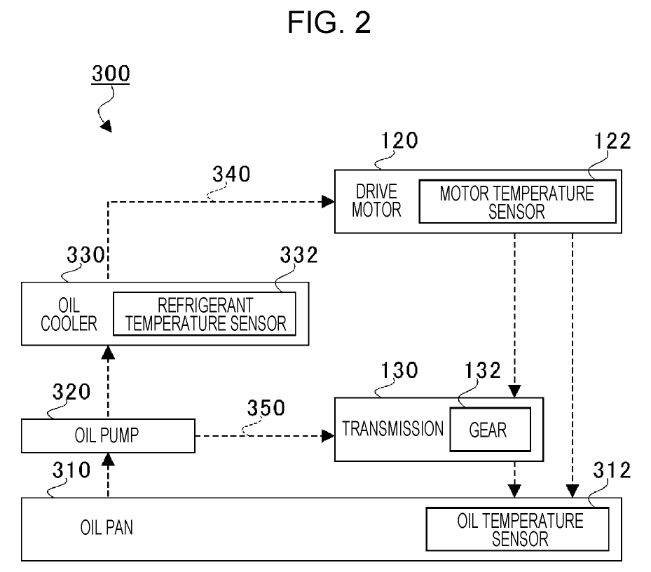

FIG. 2 is a schematic configuration diagram of the oil circuit 300 according to the embodiment. As illustrated in FIG. 2, the oil circuit 300 includes an oil pan 310, an oil pump 320, an oil cooler 330, a first oil circuit 340, and a second oil circuit 350. Additionally, in the embodiment, since hydraulic pressure is not used for shift control of the transmission 130, no hydraulic pressure sensor is provided in the oil circuit 300.

The drive motor 120 is provided with a motor temperature sensor 122. The motor temperature sensor 122 detects the temperature of the drive motor 120 and transmits information on the temperature of the drive motor 120, which is the detected value, to the control device 400. Note that the motor temperature sensor 122 may alternatively be disposed near the drive motor 120 to detect the ambient temperature around the drive motor 120. For example, the motor temperature sensor 122 may be a gear temperature sensor provided on a gear 132 of the transmission 130, which is configured to detect the temperature of the gear 132. In such a case, the gear temperature sensor serving as the motor temperature sensor 122 transmits information on the temperature of the gear 132, which is the detected value, to the control device 400 as information on the temperature of the drive motor 120.

The oil pan 310 is a container capable of storing oil. Oil is stored inside the oil pan 310. This oil is used to cool and lubricate the drive motor 120 and the gear 132 of the transmission 130. The oil pan 310 is provided with an oil temperature sensor 312. The oil temperature sensor 312 detects the temperature of the oil stored in the oil pan 310 and transmits information on the oil temperature, which is the detected value, to the control device 400.

The oil pump 320 draws up the oil stored in the oil pan 310 and supplies it to various parts of the vehicle 100. It is configured that the oil supplied to various parts of the vehicle 100 returns to the oil pan 310. For example, the oil pump 320 supplies the oil stored in the oil pan 310 to the drive motor 120 and the gear 132 of the transmission 130, and the oil supplied to the drive motor 120 and the gear 132 of the transmission 130 returns to the oil pan 310.

The oil cooler 330 cools oil circulating through the oil circuit 300. In the embodiment, the oil cooler 330 is provided in the first oil circuit 340 to cool the oil circulating through the first oil circuit 340. Note that the disclosure is not limited to this; the oil cooler 330 may instead be provided in the second oil circuit 350 to cool the oil circulating through the second oil circuit 350. Alternatively, the oil cooler 330 may cool both the oil circulating through the first oil circuit 340 and the oil circulating through the second oil circuit 350.

The oil cooler 330 is provided with a refrigerant temperature sensor 332. The refrigerant temperature sensor 332 detects the temperature of a refrigerant that exchanges heat with the oil flowing through the oil cooler 330, and transmits information on the temperature of the refrigerant, which is the detected value, to the control device 400. Hereinafter, the temperature of the refrigerant that exchanges heat with the oil flowing through the oil cooler 330 may simply be referred to as the "refrigerant temperature". In the embodiment, the refrigerant is air, and the refrigerant temperature sensor 332 is an outside air temperature sensor. Note that the disclosure is not limited to this; when the refrigerant is water, for example, the refrigerant temperature sensor 332 may be a temperature sensor that directly detects the temperature of water flowing through a pipe inside the oil cooler 330.

The first oil circuit 340 is a circuit that circulates through the oil pan 310 and the drive motor 120. The first oil circuit 340 guides oil in the following order: oil pan 310, oil pump 320, oil cooler 330, drive motor 120, and oil pan 310.

The second oil circuit 350 is a circuit that circulates through the oil pan 310 and the gear 132. The second oil circuit 350 guides oil in the following order: oil pan 310, oil pump 320, gear 132 of the transmission 130, and oil pan 310.

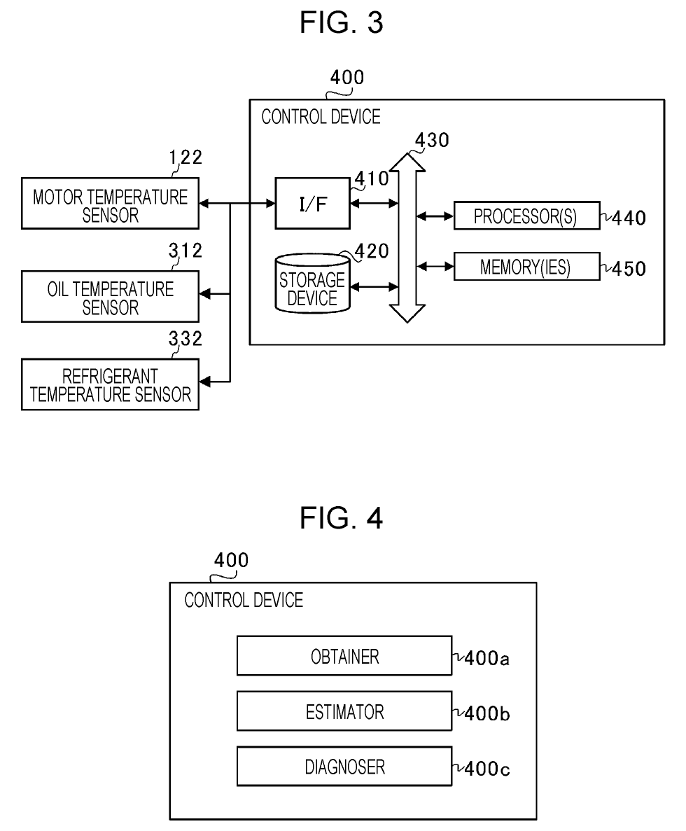

FIG. 3 is a block diagram illustrating an example of the configuration of the control device 400 according to the embodiment. The control device 400 controls the entire vehicle 100. As illustrated in FIG. 3, the control device 400 includes an interface (I/F) 410, a storage device 420, a system bus 430, one or more processors 440, and one or more memories 450. The I/F 410 is an interface for communicating with the motor temperature sensor 122, the oil temperature sensor 312, and the refrigerant temperature sensor 332. For example, the I/F 410 obtains information transmitted from the motor temperature sensor 122, the oil temperature sensor 312, the refrigerant temperature sensor 332.

The storage device 420 is configured with a random-access memory (RAM), flash memory, hard disk drive (HDD), and the like, and holds various information necessary for the processing of the processor(s) 440 discussed below. The system bus 430 is a transmission line that electrically couples the I/F 410, the storage device 420, the processor(s) 440, and the memory(ies) 450, and transmits data among these devices.

The processor(s) 440 includes, for example, a central processing unit (CPU). The memory(ies) 450 includes, for example, a read-only memory (ROM) and RAM. The ROM is a storage element that stores programs and operational parameters for use by the CPU. The RAM is a storage element that temporarily stores data such as variables and parameters used for processing executed by the CPU.

FIG. 4 is a block diagram illustrating an example of the functional configuration of the control device 400 according to the embodiment. For example, as illustrated in FIG. 4, the control device 400 includes an obtainer 400a, an estimator 400b, and a diagnoser 400c.

The processor(s) 440 cooperates with programs included in the memory(ies) 450 and executes the programs included in the memory(ies) 450, thereby implementing various processes including later-described processes performed by the obtainer 400a, the estimator 400b, and the diagnoser 400c mentioned above.

The obtainer 400a obtains information on the temperature of the drive motor 120 from the motor temperature sensor 122. The obtainer 400a also obtains information on the temperature of the oil stored in the oil pan 310 from the oil temperature sensor 312. The obtainer 400a further obtains information on the temperature on the refrigerant from the refrigerant temperature sensor 332. Moreover, the obtainer 400a obtains driving state information which is information on the driving state of the drive motor 120. The driving state information is information that serves as an index indicating the driving state of the drive motor 120, and includes, for example, various information that varies according to changes in the driving state of the drive motor 120. The driving state information includes, for example, information on the motor rotational speed and information on the torque of the drive motor 120.

The estimator 400b estimates the temperature of the drive motor 120 and the temperature of the oil in the oil pan 310 based on the driving state information, which is the information on the driving state of the drive motor 120. The temperatures to be estimated by the estimator 400b are also referred to as the "target temperatures". The estimator 400b will be described in detail later.

The diagnoser 400c diagnoses an abnormality in the oil circuit 300 based on a result of a comparison between the estimated values of the target temperatures, which are estimated by the estimator 400b, and the detected values of the target temperatures, which are detected by the motor temperature sensor 122 and the oil temperature sensor 312. The diagnoser 400c will be described in detail later.

By the way, there are cases where shifting of the transmission 130 is not performed hydraulically but is performed electrically. In such cases, no hydraulic pressure sensor is provided in the oil circuit 300; accordingly, an abnormality in the oil circuit 300, such as damage to the oil pump 320 provided in the oil circuit 300 or clogging of the oil circuit 300, is no longer undetectable based on a detected value of the hydraulic pressure sensor.

When an abnormality in the oil circuit 300, such as damage to the oil pump 320 or clogging of the oil circuit 300, occurs, the amount of oil flowing through the oil circuit 300 decreases. Consequently, the amount of oil supplied to the drive motor 120 and the amount of oil flowing through the oil cooler 330 decrease, causing the temperature of the drive motor 120 and the temperature of the oil in the oil pan 310 to become higher than when the oil circuit 300 is normal.

Accordingly, the estimator 400b of the embodiment estimates the temperature of the drive motor 120 and the temperature of the oil in the oil pan 310, which are the target temperatures, based on the driving state information, which is the information on the driving state of the drive motor 120. Here, in one example, the estimator 400b estimates, as the target temperatures, the temperature of the drive motor 120 and the temperature of the oil in the oil pan 310 when the oil circuit 300 is normal. The diagnoser 400c then diagnoses an abnormality in the oil circuit 300 based on a result of a comparison between the estimated values of the target temperatures and the detected values of the target temperatures detected by the motor temperature sensor 122 and the oil temperature sensor 312.

In one example, when the difference between the estimated value and the detected value of each target temperature is greater than or equal to a threshold, the diagnoser 400c determines that the actual temperature greatly deviates from the temperature when the oil circuit 300 is normal, and therefore determines that an abnormality has occurred in the oil circuit 300. Conversely, when the difference between the estimated value and the detected value of each target temperature is below the threshold, the diagnoser 400c determines that the actual temperature does not greatly deviate from the temperature when the oil circuit 300 is normal, and therefore determines that no abnormality has occurred in the oil circuit 300.

In the embodiment, when both the difference between the estimated value and the detected value of the temperature of the drive motor 120 and the difference between the estimated value and the detected value of the temperature of the oil in the oil pan 310 are greater than or equal to their respective thresholds, the diagnoser 400c determines that an abnormality has occurred in the oil circuit 300. Note that the disclosure is not limited to this; when either the difference between the estimated value and the detected value of the temperature of the drive motor 120 or the difference between the estimated value and the detected value of the temperature of the oil in the oil pan 310 is greater than or equal to the corresponding threshold, the diagnoser 400c may determine that an abnormality has occurred in the oil circuit 300.

In one example, when the difference between the estimated value and the detected value of the temperature of the drive motor 120 under normal conditions is greater than or equal to a first threshold, the diagnoser 400c may determine that an abnormality has occurred in the oil circuit 300, and when the difference is less than the first threshold, may determine that no abnormality has occurred in the oil circuit 300. Similarly, when the difference between the estimated value and the detected value of the temperature of the oil in the oil pan 310 under normal conditions is greater than or equal to a second threshold, the diagnoser 400c may determine that an abnormality has occurred in the oil circuit 300, and when the difference is less than the second threshold, may determine that no abnormality has occurred in the oil circuit 300. Here, the first threshold and the second threshold may be the same value or different values. In other words, the diagnoser 400c may determine that an abnormality has occurred in the oil circuit 300 when at least one of the differences, one between the estimated value and the detected value of the temperature of the drive motor 120 and the other between the estimated value and the detected value of the temperature of the oil in the oil pan 310, is greater than or equal to the corresponding threshold.

As described above, because the diagnoser 400c determines an abnormality in the oil circuit 300 based on a result of a comparison between the estimated value and the detected value of each target temperature, the diagnoser 400c can detect an abnormality in the oil circuit 300 even when no hydraulic pressure sensor is provided in the oil circuit 300. Hereinafter, the estimation methods for the temperature of the drive motor 120 and the temperature of the oil in the oil pan 310, which are the target temperatures, will be described. First, the estimation method for the temperature of the drive motor 120 will be described, followed by the estimation method for the temperature of the oil in the oil pan 310. Estimation Method for Temperature of Drive Motor 120

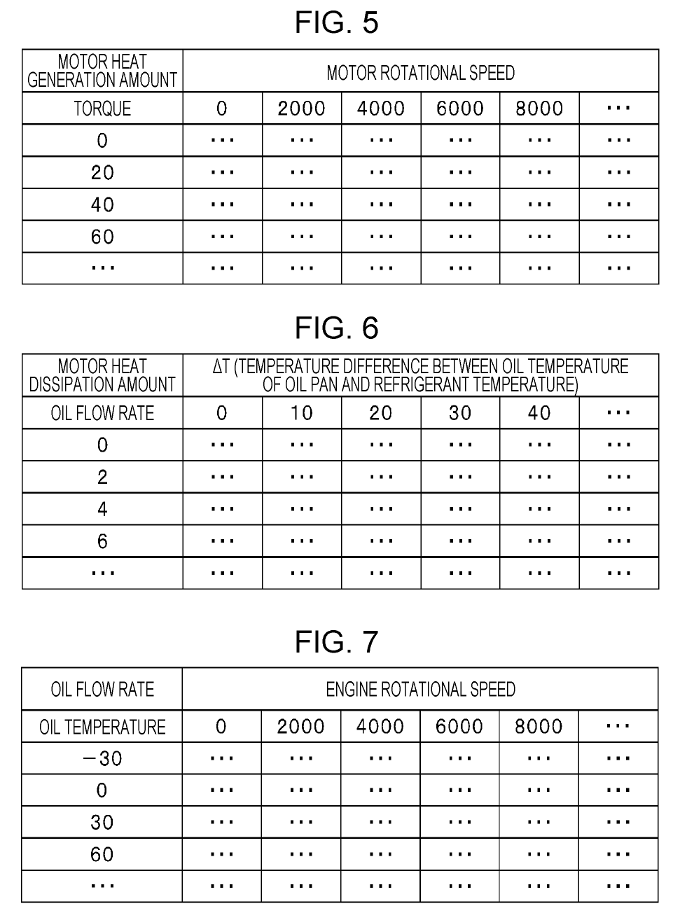

FIG. 5 is a diagram illustrating an example of a motor heat generation map according to the embodiment. The motor heat generation map is created in advance based on data obtained through experiments or the like, and is stored in the storage device 420. As illustrated in FIG. 5, the motor heat generation map is a map that associates the motor rotational speed of the drive motor 120, the torque of the drive motor 120, and the heat generation amount of the drive motor 120. Hereinafter, the amount of heat generated by the drive motor 120 may be simply referred to as the "motor heat generation amount". The greater the motor rotational speed of the drive motor 120, the greater the heat generation amount of the drive motor 120. Likewise, the greater the torque of the drive motor 120, the greater the heat generation amount of the drive motor 120. The estimator 400b refers to the motor heat generation map stored in the storage device 420 and derives the heat generation amount of the drive motor 120 based on the motor rotational speed and torque of the drive motor 120.

FIG. 6 is a diagram illustrating an example of a motor heat dissipation map according to the embodiment. The motor heat dissipation map is created in advance based on data obtained through experiments or the like, and is stored in the storage device 420. As illustrated in FIG. 6, the motor heat dissipation map associates the temperature difference ΔT between the oil temperature of the oil pan 310 and the temperature of the refrigerant, the flow rate of the oil flowing through the first oil circuit 340, and the heat dissipation amount of the drive motor 120 due to the oil flowing through the first oil circuit 340. Hereinafter, the amount of heat dissipated by the drive motor 120 may be simply referred to as the "motor heat dissipation amount". The greater the temperature difference ΔT, the greater the heat dissipation amount of the drive motor 120. Likewise, the greater the oil flow rate, the greater the heat dissipation amount of the drive motor 120. The estimator 400b refers to the motor heat dissipation map stored in the storage device 420 and derives the heat dissipation amount of the drive motor 120 based on the oil flow rate and the temperature difference ΔT.

Here, in the process of estimating the heat dissipation amount of the drive motor 120 using the motor heat dissipation map, the temperature of the oil in the oil pan 310, which is detected by the oil temperature sensor 312, may be used as the oil temperature of the oil pan 310. Additionally, in this estimation process, the temperature of the refrigerant detected by the refrigerant temperature sensor 332 may be used as the refrigerant temperature. The estimator 400b derives the temperature difference ΔT by subtracting the refrigerant temperature from the oil temperature of the oil pan 310. Moreover, the flow rate of the oil flowing through the first oil circuit 340 is derived by referring to an oil flow rate map described below.

FIG. 7 is a diagram illustrating an example of the oil flow rate map according to the embodiment. The oil flow rate map is created in advance based on data obtained through experiments or the like, and is stored in the storage device 420. As illustrated in FIG. 7, the oil flow rate map is a map that associates the engine rotational speed, the oil temperature of the oil pan 310, and the flow rate of the oil discharged from the oil pump 320. In the embodiment, the oil pump 320 is driven by the engine 110. As the engine rotational speed increases, the rotational speed of the oil pump 320 increases, resulting in a greater oil flow rate. Furthermore, as the oil temperature of the oil pan 310 increases, the kinematic viscosity of the oil decreases, resulting in a greater oil flow rate. The estimator 400b refers to the oil flow rate map stored in the storage device 420 and derives the oil flow rate for cooling the drive motor 120 and the gear 132 based on the engine rotational speed and the oil temperature of the oil pan 310.

In the embodiment, an example will now be described in which the engine rotational speed is associated with the oil flow rate map. Note that the disclosure is not limited to this; when the oil pump 320 is driven by the drive motor 120, the motor rotational speed of the drive motor 120, instead of the engine rotational speed, may be associated with the oil flow rate map. Alternatively, for example, the vehicle speed, instead of the engine rotational speed, may be associated with the oil flow rate map. Furthermore, for example, the rotational speed of the oil pump 320, instead of the engine rotational speed, may be associated with the oil flow rate map.

Here, the flow rate of the oil flowing through the first oil circuit 340 and the flow rate of the oil flowing through the second oil circuit 350 can be derived by referring to the oil flow rate map illustrated in FIG. 7. In one example, the ratio of the amount of oil branching between the first oil circuit 340 and the second oil circuit 350 in the oil circuit 300 is set in advance. For example, when the ratio of the oil branching between the first oil circuit 340 and the second oil circuit 350 is 6:4, the estimator 400b derives, as the motor oil flow rate of the oil flowing through the first oil circuit 340, the oil flow rate by multiplying the oil flow rate derived based on the oil flow rate map by 6/10. Likewise, the estimator 400b derives, as the gear oil flow rate of the oil flowing through the second oil circuit 350, the oil flow rate by multiplying the oil flow rate derived based on the oil flow rate map by 4/10.

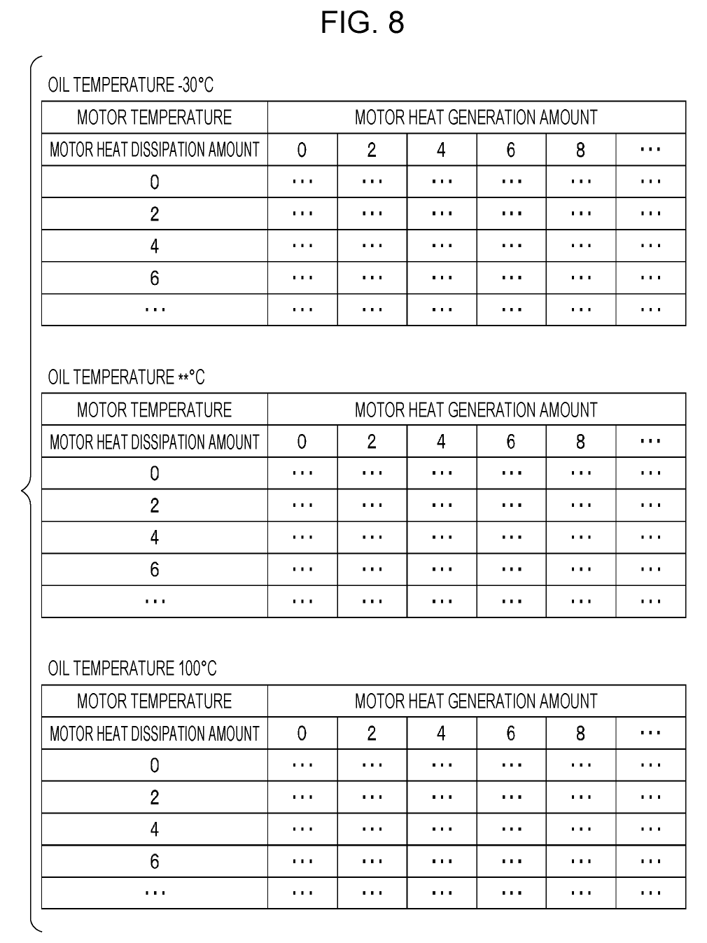

FIG. 8 is a diagram illustrating an example of a motor temperature map according to the embodiment. The motor temperature map is created in advance based on data obtained through experiments or the like, and is stored in the storage device 420. As illustrated in FIG. 8, the motor temperature map is a map that associates the motor heat generation amount, the motor heat dissipation amount of the drive motor 120 due to the oil flowing through the oil circuit 300, and the motor temperature, which is the temperature of the drive motor 120. The greater the motor heat generation amount, the higher the motor temperature. Likewise, the greater the motor heat dissipation amount, the lower the motor temperature. The estimator 400b refers to the motor temperature map stored in the storage device 420 and derives the motor temperature based on the motor heat generation amount and the motor heat dissipation amount. Here, the motor heat generation amount is derived by referring to the motor heat generation map illustrated in FIG. 5. Additionally, the motor heat dissipation amount is derived by referring to the motor heat dissipation map illustrated in FIG. 6.

Note that the motor temperature varies according to the oil temperature, which is the temperature of the oil stored in the oil pan 310. In one example, the higher the initial oil temperature of the oil pan 310, the higher the motor temperature; and the lower the initial oil temperature of the oil pan 310, the lower the motor temperature. Therefore, as illustrated in FIG. 8, the storage device 420 stores multiple types of motor temperature maps that differ in numerical values according to the oil temperature. From among these multiple types of motor temperature maps stored in the storage device 420, the estimator 400b refers to the motor temperature map according to the initial oil temperature of the oil pan 310, and derives the motor temperature based on the motor heat generation amount and the motor heat dissipation amount. The estimator 400b estimates the derived motor temperature as the temperature of the current drive motor 120 when the oil circuit 300 is normal.

Estimation Method for Temperature of Oil in Oil Pan 310

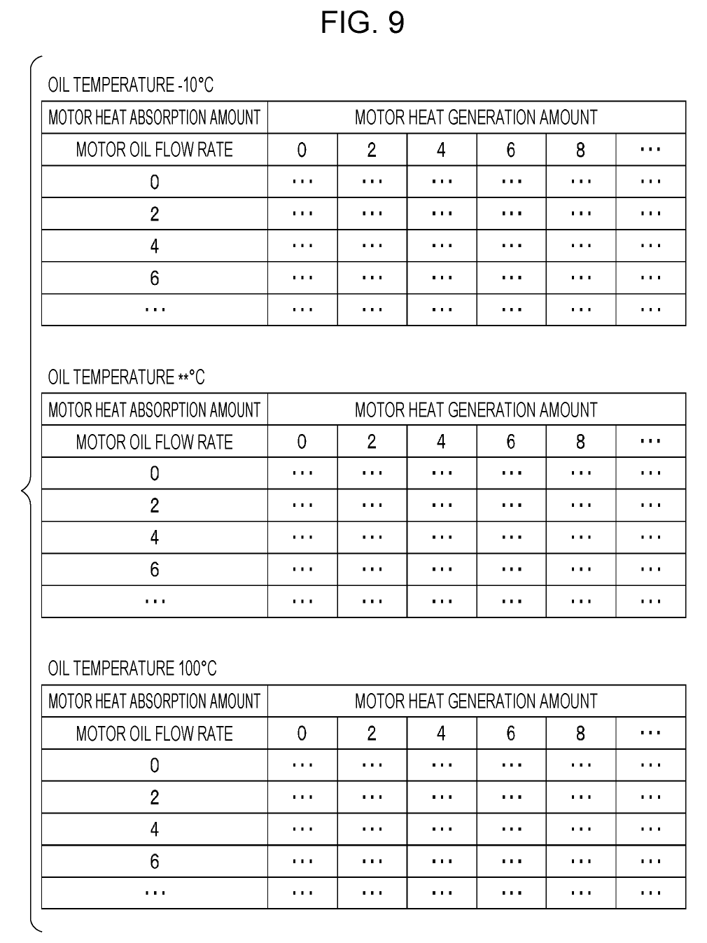

FIG. 9 is a diagram illustrating an example of a motor heat absorption map according to the embodiment. The motor heat absorption map is a map created in advance based on data obtained through experiments or the like, and is stored in the storage device 420. As illustrated in FIG. 9, the motor heat absorption map is a map that associates the motor heat generation amount of the drive motor 120, the motor oil flow rate of the oil returning from the drive motor 120 to the oil pan, and the amount of heat absorbed by the oil from the drive motor 120. Hereinafter, the amount of heat absorbed by the oil from the drive motor 120 may be simply referred to as the "motor heat absorption amount". The greater the motor heat generation amount, the greater the motor heat absorption amount. Likewise, the greater the motor oil flow rate, the greater the motor heat absorption amount. Here, the motor oil flow rate is the amount of oil circulating through the first oil circuit 340 and is derived by referring to the oil flow rate map illustrated in FIG. 7, as described above.

Note that the kinematic viscosity of the oil varies according to the oil temperature. When the kinematic viscosity of the oil varies, for example, the way the oil scatters changes even with the same amount of oil; thus, the amount of scattered oil contacting the drive motor 120 varies. In one example, as the oil temperature increases, the kinematic viscosity decreases, and the oil changes to scatter widely, resulting in a greater amount of oil contacting the drive motor 120. Therefore, as illustrated in FIG. 9, the storage device 420 stores multiple types of motor heat absorption maps that differ in numerical values according to the oil temperature. From among these multiple types of motor heat absorption maps stored in the storage device 420, the estimator 400b refers to the motor heat absorption map according to the oil temperature, and derives the amount of heat absorbed by the oil from the drive motor 120 based on the motor heat generation amount and the motor oil flow rate.

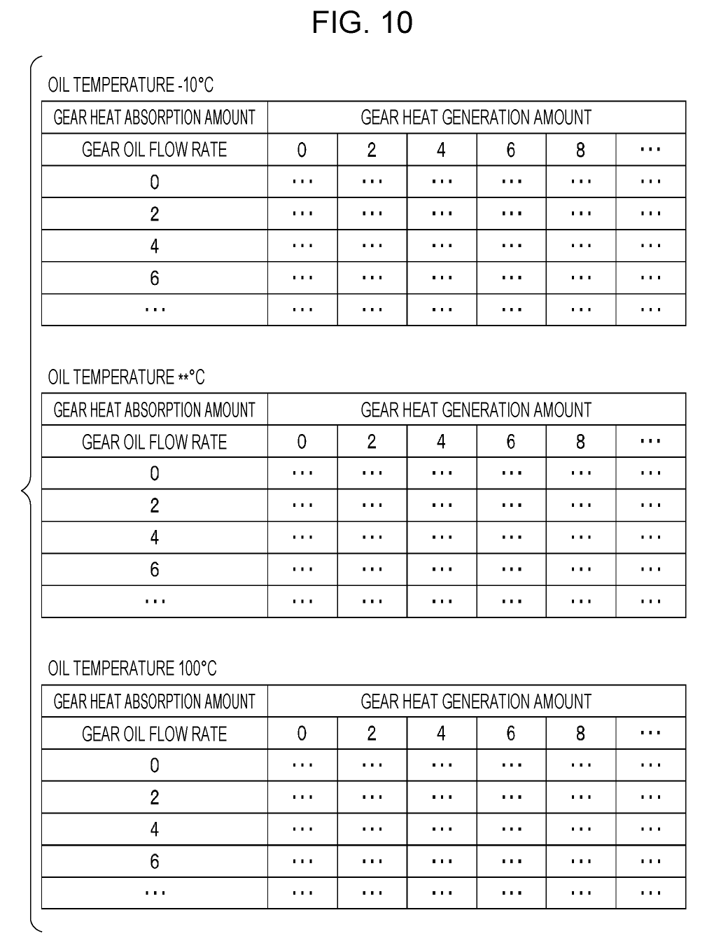

FIG. 10 is a diagram illustrating an example of a gear heat absorption map according to the embodiment. The gear heat absorption map is created in advance based on data obtained through experiments or the like, and is stored in the storage device 420. As illustrated in FIG. 10, the gear heat absorption map is a map that associates the gear heat generation amount of the gear 132, the gear oil flow rate of the oil returning from the gear 132 to the oil pan, and the amount of heat absorbed by the oil from the gear 132. Hereinafter, the amount of heat absorbed by the oil from the gear 132 may be simply referred to as the "gear heat absorption amount". The greater the gear heat generation amount, the greater the gear heat absorption amount. Likewise, the greater the gear oil flow rate, the greater the gear heat absorption amount. Here, the gear oil flow rate is the amount of oil flowing through the second oil circuit 350 and is derived by referring to the oil flow rate map illustrated in FIG. 7, as described above. For example, when the ratio of the oil branching between the first oil circuit 340 and the second oil circuit 350 is 6:4, the estimator 400b derives, as the gear oil flow rate of the oil flowing through the second oil circuit 350, the oil flow rate by multiplying the oil flow rate derived based on the oil flow rate map by 4/10. Additionally, the gear heat generation amount is derived by referring to a gear heat generation map, which will be described later.

Since the kinematic viscosity of oil varies according to the oil temperature, as illustrated in FIG. 10, the storage device 420 stores multiple types of gear heat absorption maps that differ in numerical values according to the oil temperature. From among these multiple types of gear heat absorption maps stored in the storage device 420, the estimator 400b refers to the gear heat absorption map according to the oil temperature, and derives the amount of heat absorbed by the oil from the gear 132 based on the gear heat generation amount and the gear oil flow rate.

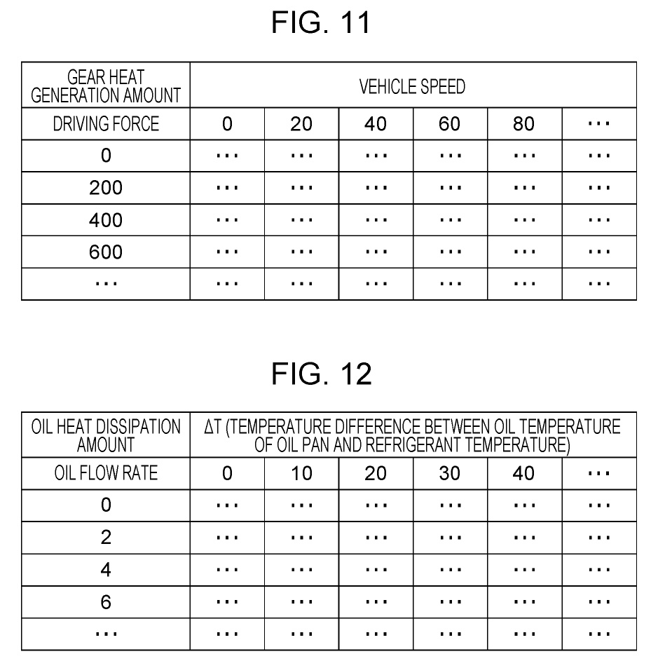

FIG. 11 is a diagram illustrating an example of the gear heat generation map according to the embodiment. The gear heat generation map is created in advance based on data obtained through experiments or the like, and is stored in the storage device 420. As illustrated in FIG. 11, the gear heat generation map is a map that associates the vehicle speed of the vehicle 100, the driving power of the vehicle 100, and the gear heat generation amount, which is the amount of heat generated by the gear 132 while the vehicle 100 is being driven. Here, the driving power of the vehicle 100 is determined from the rotational speed and torque transmitted to the wheels. The greater the vehicle speed, the greater the gear heat generation amount. Likewise, the greater the driving power, the greater the gear heat generation amount. The estimator 400b refers to the gear heat generation map stored in the storage device 420 and derives the gear heat generation amount based on the vehicle speed and the driving power.

FIG. 12 is a diagram illustrating an example of an oil heat dissipation map according to the embodiment. The oil heat dissipation map is created in advance based on data obtained through experiments or the like, and is stored in the storage device 420. As illustrated in FIG. 12, the oil heat dissipation map is a map that associates the temperature difference ΔT between the oil temperature of the oil pan 310 and the temperature of the refrigerant, the flow rate of the oil flowing through the oil circuit 300, and the amount of heat dissipated by the oil in the oil circuit 300. Hereinafter, the amount of heat dissipated by the oil in the oil circuit 300 may be simply referred to as the "oil heat dissipation amount". The greater the temperature difference ΔT, the greater the oil heat dissipation amount. Likewise, the greater the oil flow rate, the greater the oil heat dissipation amount. The estimator 400b refers to the oil heat dissipation amount map stored in the storage device 420 and derives the heat dissipation amount of the oil in the oil circuit 300 based on the oil flow rate and the temperature difference ΔT.

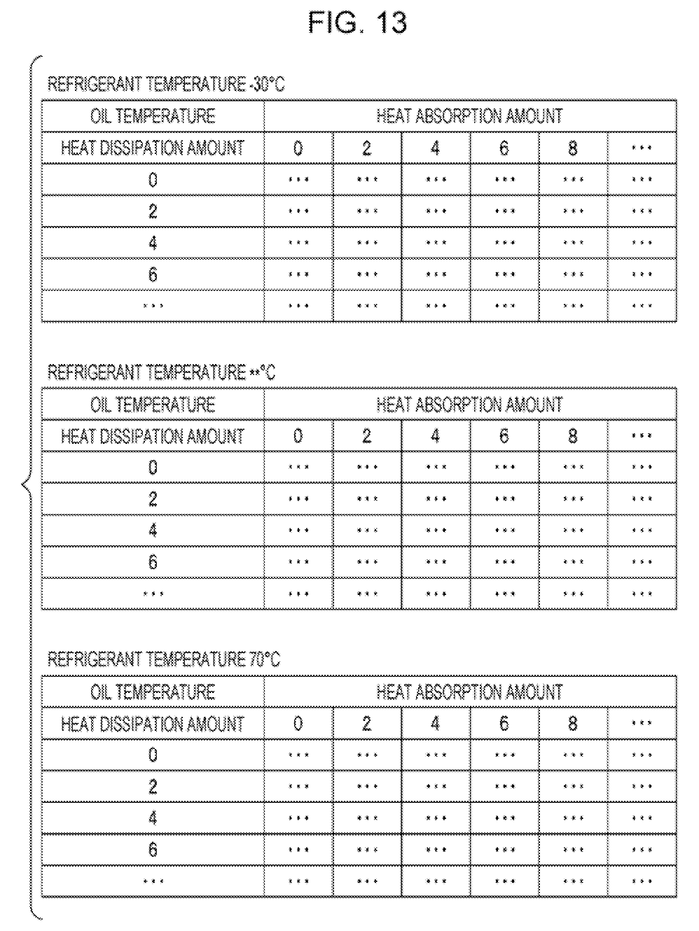

FIG. 13 is a diagram illustrating an example of an oil temperature map according to the embodiment. The oil temperature map is created in advance based on data obtained through experiments or the like, and is stored in the storage device 420. As illustrated in FIG. 13, the oil temperature map is a map that associates the heat absorption amount, the heat dissipation amount of the oil in the oil circuit 300, and the oil temperature, which is the temperature of the oil in the oil pan 310. The greater the heat absorption amount, the higher the oil temperature. Likewise, the greater the heat dissipation amount, the lower the oil temperature. The estimator 400b refers to the oil temperature map stored in the storage device 420 and derives the oil temperature of the oil pan 310 based on the heat absorption amount and the heat dissipation amount. Here, the heat absorption amount refers to the added heat absorption amount, which is the sum of the amount of heat absorbed by the oil from the drive motor 120 derived by referring to the motor heat absorption map illustrated in FIG. 9, and the amount of heat absorbed by the oil from the gear 132 derived by referring to the gear heat absorption map illustrated in FIG. 10. Additionally, the heat dissipation amount refers to the oil heat dissipation amount derived by referring to the oil heat dissipation map illustrated in FIG. 12.

Note that the oil temperature varies according to the temperature of the refrigerant that exchanges heat with the oil flowing through the oil cooler 330. In one example, the higher the initial temperature of the refrigerant, the higher the oil temperature; and the lower the initial temperature of the refrigerant, the lower the oil temperature. Therefore, as illustrated in FIG. 13, the storage device 420 stores multiple types of oil temperature maps that differ in numerical values according to the refrigerant temperature. From among these multiple types of oil temperature maps stored in the storage device 420, the estimator 400b refers to the oil temperature map according to the initial temperature of the refrigerant, and derives the oil temperature based on the heat absorption amount and the heat dissipation amount. The estimator 400b estimates the derived oil temperature as the temperature of the oil in the current oil pan 310 when the oil circuit 300 is normal.

In the embodiment, an example has been described in which the target temperatures are the temperature of the drive motor 120 and the temperature of the oil in the oil pan 310. However, the disclosure is not limited to this; the target temperature may be either the temperature of the drive motor 120 or the temperature of the oil in the oil pan 310.

For example, the estimator 400b estimates the temperature of the drive motor 120 based on the motor temperature map illustrated in FIG. 8. The diagnoser 400c then compares the estimated value of the temperature of the drive motor 120 estimated by the estimator 400b with the detected value detected by the motor temperature sensor 122. When the difference between the estimated value and the detected value is less than the first threshold, the diagnoser 400c determines that no abnormality has occurred in the oil circuit 300. When the difference between the estimated value and the detected value is greater than or equal to the first threshold, the diagnoser 400c determines that an abnormality has occurred in the oil circuit 300.

Additionally, for example, the estimator 400b estimates the temperature of the oil in the oil pan 310 based on the oil temperature map illustrated in FIG. 13. The diagnoser 400c then compares the estimated value of the oil temperature estimated by the estimator 400b with the detected value detected by the oil temperature sensor 312. When the difference between the estimated value and the detected value is less than the second threshold, the diagnoser 400c determines that no abnormality has occurred in the oil circuit 300. When the difference between the estimated value and the detected value is greater than or equal to the second threshold, the diagnoser 400c determines that an abnormality has occurred in the oil circuit 300.

Note that the target temperature may alternatively be the temperature of the gear 132. In that case, the temperature of the gear 132 is used and regarded as the temperature of the drive motor 120. The temperature of the gear 132 may be estimated by, for example, a method in which the temperatures in "Estimation Method for Temperature of Drive Motor 120" are all replaced with the temperature of the gear 132. The diagnoser 400c then compares the estimated value of the temperature of the gear 132 estimated by the estimator 400b with the detected value detected by the gear temperature sensor. When the difference between the estimated value and the detected value is less than a third threshold, the diagnoser 400c determines that no abnormality has occurred in the oil circuit 300. When the difference between the estimated value and the detected value is greater than or equal to the third threshold, the diagnoser 400c determines that an abnormality has occurred in the oil circuit 300. Here, the third threshold may be the same as or different from the first and second thresholds.

Additionally, in the embodiment, an example has been described in which, when both the difference between the estimated value and the detected value of the temperature of the drive motor 120 and the difference between the estimated value and the detected value of the temperature of the oil in the oil pan 310 are greater than or equal to their respective thresholds, the diagnoser 400c determines that an abnormality has occurred in the oil circuit 300. However, the disclosure is not limited to this; when both the difference between the estimated value and the detected value of the temperature of the gear 132 and the difference between the estimated value and the detected value of the temperature of the oil in the oil pan 310 are greater than or equal to their respective thresholds, the diagnoser 400c may determine that an abnormality has occurred in the oil circuit 300.

Alternatively, when either the difference between the estimated value and the detected value of the temperature of the gear 132 or the difference between the estimated value and the detected value of the temperature of the oil in the oil pan 310 is greater than or equal to the corresponding threshold, the diagnoser 400c may determine that an abnormality has occurred in the oil circuit 300. In one example, when the difference between the estimated value and the detected value of the temperature of the gear 132 under normal conditions is greater than or equal to the third threshold, the diagnoser 400c may determine that an abnormality has occurred in the oil circuit 300. Likewise, when the difference between the estimated value and the detected value of the temperature of the oil in the oil pan 310 under normal conditions is greater than or equal to the second threshold, the diagnoser 400c may determine that an abnormality has occurred in the oil circuit 300. In other words, when at least one of the difference between the estimated value and the detected value of the temperature of the gear 132 and the difference between the estimated value and the detected value of the temperature of the oil in the oil pan 310 is greater than or equal to the corresponding threshold, the diagnoser 400c may determine that an abnormality has occurred in the oil circuit 300.

According to the embodiment as above, the estimator 400b estimates the temperature of the drive motor 120 and the temperature of the oil in the oil pan 310, which are the target temperatures, based on driving state information which is information on the driving state of the drive motor 120. The diagnoser 400c then diagnoses an abnormality in the oil circuit 300 based on a result of a comparison between the estimated values of the target temperatures and the detected values of the target temperatures detected by the motor temperature sensor 122 and the oil temperature sensor 312. Since an abnormality in the oil circuit 300 is determined based on a result of a comparison between the estimated value and the detected value of each target temperature, an abnormality in the oil circuit 300 can be detected even when no hydraulic pressure sensor is provided in the oil circuit 300.

In some embodiments, the driving state information includes information on the motor rotational speed of the drive motor 120, and the estimator 400b estimates the temperature of the drive motor 120 and the temperature of the oil in the oil pan 310, which are the target temperatures, based on the driving state information including information on the motor rotational speed. In this way, the estimator 400b can estimate the temperature of the drive motor 120 and the temperature of the oil in the oil pan 310 while taking into account the temperature of the drive motor 120 that varies according to the motor rotational speed.

In some embodiments, the driving state information includes information on the torque of the drive motor 120, and the estimator 400b estimates the temperature of the drive motor 120 and the temperature of the oil in the oil pan 310, which are the target temperatures, based on the driving state information including the torque information. In this way, the estimator 400b can estimate the temperature of the drive motor 120 and the temperature of the oil in the oil pan 310 while taking into account the temperature of the drive motor 120 that varies according to the torque of the drive motor 120.

In some embodiments, the oil circuit 300 includes the first oil circuit 340 circulating through the oil pan 310 and the drive motor 120, and the second oil circuit 350 circulating through the oil pan 310 and the gear 132. The target temperature is the temperature of either the drive motor 120 or the gear 132. The estimator 400b estimates the heat generation amount of either the drive motor 120 or the gear 132 based on the driving state information. The estimator 400b also estimates the heat dissipation amount of either the drive motor 120 or the gear 132 due to the oil circuit 300 that passes through either the drive motor 120 or the gear 132. Then, the estimator 400b estimates the target temperature based on the heat generation amount and the heat dissipation amount. By estimating not only the heat generation amount but also the heat dissipation amount, the estimation accuracy of the temperature of the drive motor 120, which is the target temperature, can be improved.

In some embodiments, the target temperature is the temperature of the oil in the oil pan 310. The estimator 400b estimates, based on the driving state information, respective heat absorption amounts of the oil in the oil pan 310 due to the oil returning to the oil pan 310 from the first oil circuit 340 and the second oil circuit 350. The estimator 400b also estimates the heat dissipation amount of the oil in the oil circuit 300. Then, the estimator 400b estimates the target temperature based on the heat absorption amounts and the heat dissipation amount. By estimating not only the heat absorption amounts but also the heat dissipation amount, the estimation accuracy of the temperature of the oil in the oil pan 310, which is the target temperature, can be improved.

Although the embodiment of the disclosure has been described above with reference to the accompanying drawings, it goes without saying that the disclosure is not limited to the embodiment. It will be apparent to those skilled in the art that various modifications or alterations are conceivable within the scope of the claims, and it is to be understood that such modifications or alterations also fall within the technical scope of the disclosure.

According to the disclosure, it is possible to detect an abnormality in the oil circuit.

The control device 400 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 400 including the obtainer 400a, the estimator 400b, and the diagnoser 400c. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 4.

1. A vehicle comprising:
a drive motor;
a gear configured to transmit power from the drive motor to wheels of the vehicle;
an oil circuit configured to supply oil to the drive motor and the gear;
a sensor configured to detect a target temperature that is a temperature of the drive motor, the gear, or the oil; and
a control device comprising one or more processors and one or more memories coupled to the one or more processors;
wherein:
the one or more processors are configured to execute a process comprising:
estimating the target temperature based on driving state information that is information on a driving state of the drive motor; and
diagnosing an abnormality in the oil circuit based on a result of a comparison between an estimated value of the target temperature and a detected value of the target temperature detected by the sensor.

2. The vehicle according to claim 1, wherein the driving state information comprises information on a motor rotational speed of the drive motor.

3. The vehicle according to claim 1, wherein the driving state information comprises information on a torque of the drive motor.

4. The vehicle according to claim 1, wherein
the oil circuit comprises a first oil circuit that circulates through an oil pan and the drive motor, and a second oil circuit that circulates through the oil pan and the gear,
the target temperature is a temperature of either the drive motor or the gear, and
the one or more processors are configured to execute a process comprising:
estimating a heat generation amount of either the drive motor or the gear based on the driving state information;
estimating a heat dissipation amount of either the drive motor or the gear due to the oil circuit that passes through either the drive motor or the gear; and
estimating the target temperature based on the heat generation amount and the heat dissipation amount.

5. The vehicle according to claim 2, wherein
the oil circuit comprises a first oil circuit that circulates through an oil pan and the drive motor, and a second oil circuit that circulates through the oil pan and the gear,
the target temperature is a temperature of either the drive motor or the gear, and
the one or more processors are configured to execute a process comprising:
estimating a heat generation amount of either the drive motor or the gear based on the driving state information;
estimating a heat dissipation amount of either the drive motor or the gear due to the oil circuit that passes through either the drive motor or the gear; and
estimating the target temperature based on the heat generation amount and the heat dissipation amount.

6. The vehicle according to claim 3, wherein
the oil circuit comprises a first oil circuit that circulates through an oil pan and the drive motor, and a second oil circuit that circulates through the oil pan and the gear,
the target temperature is a temperature of either the drive motor or the gear, and
the one or more processors are configured to execute a process comprising:
estimating a heat generation amount of either the drive motor or the gear based on the driving state information;
estimating a heat dissipation amount of either the drive motor or the gear due to the oil circuit that passes through either the drive motor or the gear; and
estimating the target temperature based on the heat generation amount and the heat dissipation amount.

7. The vehicle according to claim 1, wherein
the oil circuit comprises a first oil circuit that circulates through an oil pan and the drive motor, and a second oil circuit that circulates through the oil pan and the gear,
the target temperature is a temperature of the oil in the oil pan, and
the one or more processors are configured to execute a process comprising:
estimating, based on the driving state information, respective heat absorption amounts of the oil in the oil pan due to the oil returning to the oil pan from the first oil circuit and the second oil circuit;
estimating a heat dissipation amount of the oil in the oil circuit; and
estimating the target temperature based on the heat absorption amounts and the heat dissipation amount.

8. The vehicle according to claim 2, wherein
the oil circuit comprises a first oil circuit that circulates through an oil pan and the drive motor, and a second oil circuit that circulates through the oil pan and the gear,
the target temperature is a temperature of the oil in the oil pan, and
the one or more processors are configured to execute a process comprising:
estimating, based on the driving state information, respective heat absorption amounts of the oil in the oil pan due to the oil returning to the oil pan from the first oil circuit and the second oil circuit;
estimating a heat dissipation amount of the oil in the oil circuit; and
estimating the target temperature based on the heat absorption amounts and the heat dissipation amount.

9. The vehicle according to claim 3, wherein
the oil circuit comprises a first oil circuit that circulates through an oil pan and the drive motor, and a second oil circuit that circulates through the oil pan and the gear,
the target temperature is a temperature of the oil in the oil pan, and
the one or more processors are configured to execute a process comprising:
estimating, based on the driving state information, respective heat absorption amounts of the oil in the oil pan due to the oil returning to the oil pan from the first oil circuit and the second oil circuit;
estimating a heat dissipation amount of the oil in the oil circuit; and
estimating the target temperature based on the heat absorption amounts and the heat dissipation amount.
